(19) United States
(12) Patent Application Publication
(10) Pub. No.: US 2024/0256364 A1
(43) Pub. Date: Aug. 1, 2024

(54) ERROR DETECTION AND REMEDIATION FOR APPLICATION PROGRAMMING INTERFACES

(71) Applicant: Dell Products L.P., Round Rock, TX (US)

(72) Inventors: Caoimhe Ward, Swinford (IE); Aidan Hally, Fermoy (IE); Ellen Murphy, Whites Cross (IE)

(73) Assignee: Dell Products L.P., Round Rock, TX (US)

(21) Appl. No.: 18/160,353

(22) Filed: Jan. 27, 2023

(51) Int. Cl. G06F 9/54; G06F 11/07

(52) U.S. Cl. CPC G06F 9/54; G06F 11/076; G06F 2209/501

(57) ABSTRACT

According to one aspect, a method includes: receiving, by a management server of a storage network, an application programming interface (API) call for information about one or more components of the storage network, the API call received from a client device; forwarding the API call to a subsystem of the storage network for processing; receiving a response from the subsystem, the response having a status code; detecting an error with the processing of the API call by the subsystem based, at least in part, on the status code and on comparing a time taken by the subsystem to process the API call to times taken to process other API calls; and in response to the detecting of the error, providing a recommendation to the client device to enable remediation of the error.

### BACKGROUND

A storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

Storage systems and other kinds of client-server computing systems may provide application programming interfaces (APIs) to enable users to access various features thereof. For example, using an API, a storage administrator may retrieve information about a storage group or list of groups, create new storage groups, modify an existing group, or delete a storage group.

REST APIs communicate via Hypertext Transfer Protocol (HTTP) requests to perform standard database functions like creating, reading, updating, and deleting records within a resource. For example, a REST API may use an HTTP GET request to retrieve a record, a POST request to create one, a PUT request to update a record, and a DELETE request to delete one. REST APIs are widely used in client-server computing applications.

### SUMMARY

According to one aspect of the disclosure, a method includes: receiving, by a management server of a storage network, an application programming interface (API) call for information about one or more components of the storage network, the API call received from a client device; forwarding the API call to a subsystem of the storage network for processing; receiving a response from the subsystem, the response having a status code; detecting an error with the processing of the API call by the subsystem based, at least in part, on the status code and on comparing a time taken by the subsystem to process the API call to times taken to process other API calls; and in response to the detecting of the error, providing a recommendation to the client device to enable remediation of the error.

In some embodiments, the method can further include storing information about the API call and the response to a database, the stored information including at least a type of the API call, the response status code, and the time taken by the subsystem to process the API call. In some embodiments, the method can further include: receiving, by the management server, another API call for information about one or more components of the storage network, the another API call associated with another client device; and detecting an error with the processing of the another API call using at least the information about the API call stored to the database.

In some embodiments, the providing of the recommendation to the client may include providing the recommendation within a response sent by the management server to the client device. In some embodiments, the providing of the recommendation to the client device includes presenting a graphical user interface (GUI) accessible by the client device, the GUI displaying the recommendation. In some embodiments, the API call can include a Hypertext Transfer Protocol (HTTP) request and the detecting of the error with the processing of the API call by the subsystem based includes determining if the response status code is between 200 and 299.

In some embodiments, the providing of the recommendation to the client device to enable remediation of the error may include: determining a load of the subsystem; and providing a recommendation not to use at least one of the one or more components of the storage network based on determined load. In some embodiments, the detecting of error with the processing of the API call by the subsystem includes detecting an authentication error based on the response status code, and wherein the providing of the recommendation to the client device to enable remediation of the error includes providing a recommendation that permissions associated with the client device are insufficient for the API call.

According to another aspect of the disclosure, an apparatus includes a processor a non-volatile memory storing computer program code. The computer program code, when executed on the processor causes the processor to execute a process corresponding to any of the aforementioned method embodiments.

According to another aspect of the disclosure, a non-transitory machine-readable medium encodes instructions that when executed by one or more processors cause a process to be carried out. The process can correspond to any of the aforementioned method embodiments.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a block diagram of an illustrative storage system within which embodiments of the present disclosure may be utilized.

FIG. 2 is a block diagram of a client-server system with API error detection and remediation, according to some embodiments.

FIGS. 3 and 3A are flow diagrams that shows examples of processes for API error detection and remediation, according to some embodiments.

FIG. 4 is a flow diagram illustrating another process for API error detection and remediation, according to some embodiments.

FIG. 5 is block diagram of a processing device on which methods and processes disclosed herein can be implemented, according to some embodiments of the disclosure.

The drawings are not necessarily to scale, or inclusive of all elements of a system, emphasis instead generally being placed upon illustrating the concepts, structures, and techniques sought to be protected herein.

### DETAILED DESCRIPTION

Users of client-server systems that provide APIs (e.g., REST APIs) may receive errors when invoking API calls. Certain errors may be chronic (e.g., authentication failures due to incorrect credentials or authorization failures due to lack of permission), while others may be intermittent (e.g., timeouts due to unusually system activity). In either case, certain types of errors may be resolvable by the user, or their system administrator, if the user has sufficient information regarding the nature and context of the errors. Existing storage systems and other client-server systems may not provide such information.

Disclosed herein are structures and techniques for automated detection and remediation of API errors. In some embodiments, the timing and status of particular API calls can be tracked over time and analyzed to detect API errors and provide recommendations as to specific action(s) that can be taken to resolve or manage those errors. Various other aspects and features are described in detail below.

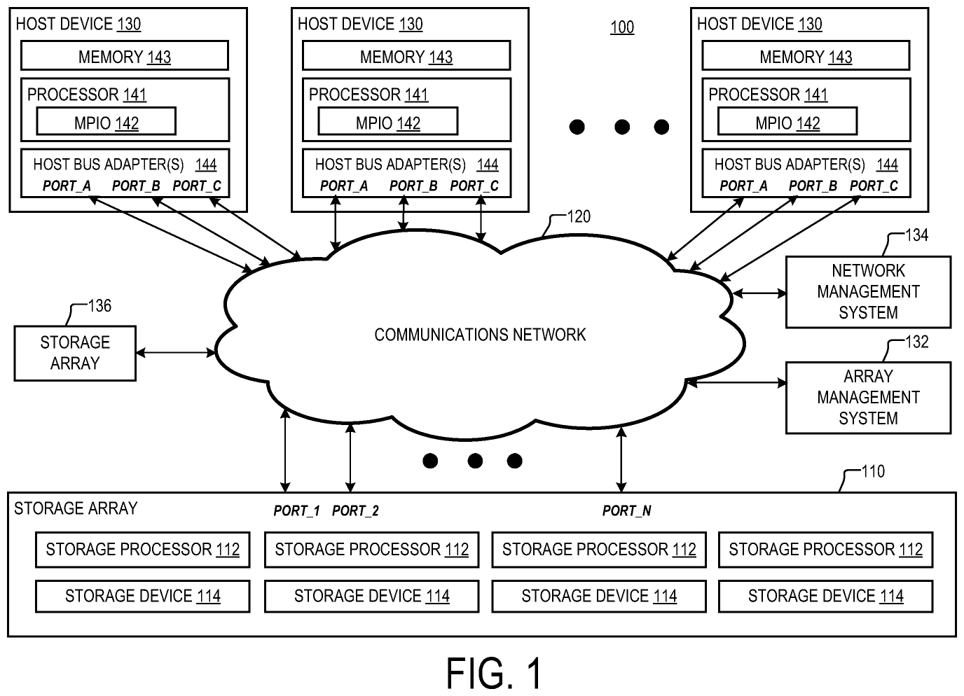

FIG. 1 is a diagram of an example of a storage system 100 within which embodiments of the present disclosure may be utilized. As illustrated, the system 100 may include a storage array 110, a communications network 120, a plurality of host devices 130, an array management system 132, a network management system 134, and a storage array 136.

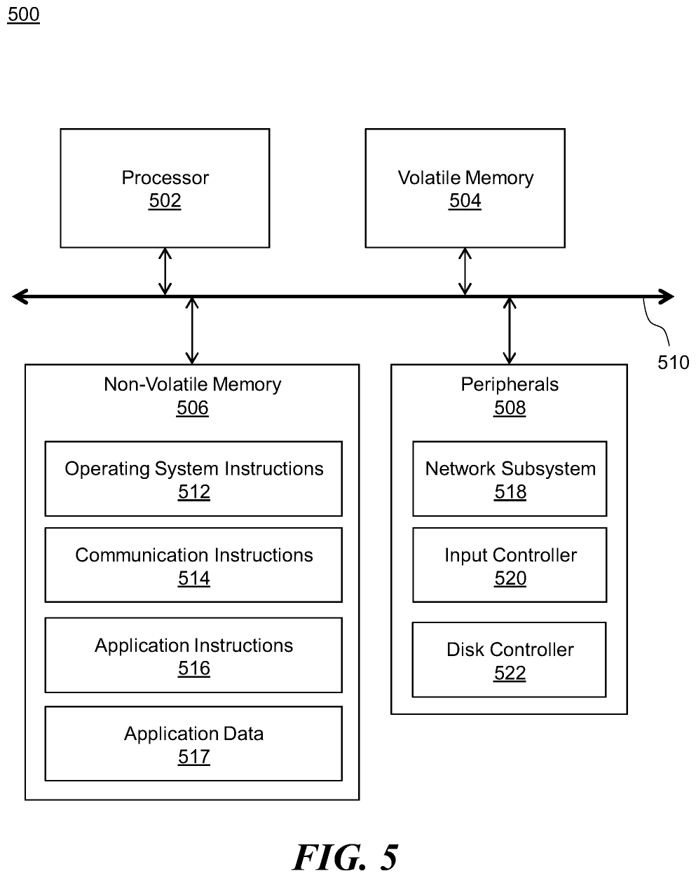

The storage array 110 may include a plurality of storage processors 112 and a plurality of storage devices 114. Each of the storage processors 112 may include a computing device that is configured to receive I/O requests from any of the host devices 130 and execute the received I/O requests by reading or writing data to the storage devices 114. In some implementations, each of the storage processors 112 may have an architecture that is the same or similar to the architecture of the computing device 500 of FIG. 5. The storage processors 112 may be located in the same geographic location or in different geographic locations. Similarly, the storage devices 114 may be located in the same geographic location or different geographic locations. Each of the storage devices 114 may include any of a solid-state drive (SSD), a non-volatile random-access memory (nvRAM) device, a non-volatile memory express (NVME) device, a hard disk (HD), and/or any other suitable type of storage device. In some implementations, the storage devices 114 may be arranged in one or more Redundant Array(s) of Independent Disks (RAID) arrays. The communications network 120 may include one or more of the Internet, a local area network (LAN), a wide area network (WAN), a fibre channel (FC) network, and/or any other suitable type of network.

Each of the host devices 130 may include a laptop, a desktop computer, a smartphone, a tablet, an Internet-of-Things device, and/or any other suitable type of electronic device that is configured to retrieve and store data in the storage arrays 110 and 136. Each host device 130 may include a memory 143, a processor 141, and one or more host bus adapters (HBAs) 144. The memory 143 may include any suitable type of volatile and/or non-volatile memory, such as a solid-state drive (SSD), a hard disk (HD), a random-access memory (RAM), a Synchronous Dynamic Random-Access Memory (SDRAM), etc. The processor 141 may include any suitable type of processing circuitry, such as a general-purpose process (e.g., an x86 processor, a MIPS processor, an ARM processor, etc.), a special-purpose processor, an application-specific integrated circuit (ASIC), a field programmable gate array (FPGA), etc. Each of the HBAs 144 may be a circuit board or integrated circuit adapter that connects a respective one of the host devices 130 to the storage array 110 (and/or storage array 136). In other words, each of the HBAs 144 may include a communications interface for connecting to the communications network 120, storage array 110 and/or storage array 136. Although in the example of FIG. 1 each of the host devices 130 is provided with at least one HBA 144, alternative implementations are possible in which the each of the host devices is provided with another type of communications interface, in addition to (or instead of) an HBA. The other type of communications interface may include one or more of an Ethernet adapter, an WiFi adapter, a local area network (LAN) adapter, etc.

Each processor 141 may be configured to execute a multi-path I/O (MPIO) driver 142. The MPIO driver 142 may comprise, for example, PowerPath™ drivers from Dell EMC™, and/or other types of MPIO drivers that are arranged to discover available communications paths any of the host devices 130 and the storage array 110. The MPIO driver 142 may be configured to select I/O operations from any of the I/O queues of the host devices 130. The sources of the I/O operations stored in the I/O queues may include respective processes of one or more applications executing on the host devices 130.

The HBA 144 of each of the host devices 130 may include one or more ports. Specifically, in the example of FIG. 1, the HBA 144 of each of the host devices 130 includes three ports, which are herein enumerated as “port A”, “port B”, and “port C”. Furthermore, the storage array 110 may also include a plurality of ports. In the example of FIG. 1, the ports in the storage array 110 are enumerated as “port 1”, “port 2,” and “port N”, where N is a positive integer greater than 2. Each of the ports in the host devices 130 may be coupled to one of the ports of the storage array via a corresponding network path. The corresponding network path may include one or more hops in the communications network 120. Under the nomenclature of the present disclosure, a network path spanning between an HBA port of one of host devices 130 and one of the ports of the storage array 110 is referred to as a “network path of that host device 130”.

Array management system 132 may include a computing device, such as the computing device 500 of FIG. 5. The array management system 132 may be used by a system administrator to re-configure the storage array 110, e.g., when degraded performance of the storage array 110 is detected.

Network management system 134 may include a computing device, such as the computing device 500 of FIG. 5. The network management system 134 may be used by a network administrator to configure the communications network 120 when degraded performance of the communications network 120 is detected.

The storage array 136 may be the same or similar to the storage array 110. The storage array 136 may be configured to store the same data as the storage array 110. The storage array 136 may be configured to operate in either active-active configuration with the storage array 110 or in active-passive configuration. When storage arrays 110 and 136 operate in active-active configuration, a write request to either of storage arrays 110 and 136 is not acknowledged back to the sender until the data associated with the write request is written to both of the storage arrays 110 and 136. When storage arrays 110 and 136 are operated in active-passive configuration, a write request to a given one of the storage arrays 110 and 136 is acknowledge for as long the data associated with write request is written to the given one of the storage arrays 110 and 136 before the writing to the other one of the storage arrays is completed.

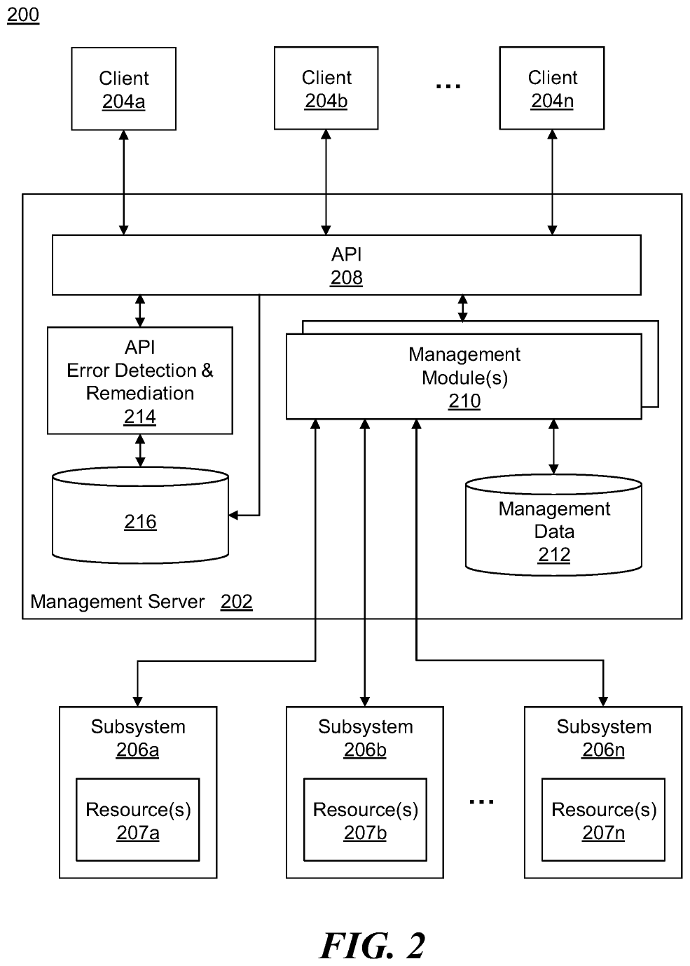

FIG. 2 shows an example of a client-server system 200 with API error detection and remediation, according to some embodiments. One or more client devices 204a, 204b, . . . , 204n (204 generally) can access a management server 202 via one or more communication networks (not shown). The illustrative system 200 can include one or more subsystems 206a, 206b, . . . , 206n (206 generally) that may be accessed by management server 202 via one or more communication networks (also not shown). Said communication networks can include, for example, the Internet, LANs, WANs, FC networks, etc. In some cases, subsystems 206 may also be accessed (directly) by clients 204.

Management server 202 can include an API module 208, one or more management modules 210, and a management data storage 212. Management modules 210 can include functions, libraries, packages, services, or other functional software units that implement specific functionality provided by management server 202. For example, management modules 210 can include software managing for various resources 207a, 207b, . . . , 207n (207 generally) that form a part of, or are otherwise associated with respective subsystems 206a, 206b, . . . , 206n. Management data store 212 can include a database or other form of storage configured to store information related to the services provided by management server 202.

Management server 202 may be hosted on one or more physical and/or virtual hardware resources, such physical/virtual processing devices, storage devices, etc. In some cases, management data storage 212 may be hosted on physical/virtual hardware that is separate from that upon which management server 202 is hosted.

In some cases, two or more different subsystems 206 may be hosted on separate physical/virtual machines or processing devices. That is, subsystems 206 can be isolated from each other such that unusually high activity/load in one subsystem 206 does not necessarily impact other subsystems.

In some embodiments, subsystems 206 may correspond to storage arrays and resources 207 may correspond to storage devices (sometimes referred to as logical unit numbers, or LUNs), storage groups, storage volumes, or other storage-related resources. For example, relating FIG. 2 to FIG. 1, subsystems 206 may correspond to storage arrays 110, 136, resources 207 may correspond to storage devices 114, and management server 202 may correspond to array management system 132 of FIG. 1. However, disclosed structures and techniques are not limited to storage systems or any other particular type of client-server systems and may be broadly applicable to any systems that involve the use of APIs.

Clients 204 can access functionality of management server 202 via API module 208. In some embodiments, API module 208 may implement a REST API. Thus, for example, a client device 204 can make API calls by sending HTTP requests to management server 202 and receiving HTTP responses therefrom. API module 208 can be configured to handle such HTTP requests by inspecting the request header information to determine an action being requested (e.g., create, read, update, or delete) and a type of resource for which that action applies (e.g., storage devices/LUNs, storage volumes, etc.). In some cases, the action can be determined by the HTTP method (e.g., POST for create, GET for read, PUT for update, or DELETE for delete). In some cases, the type of resource can be determined based on the HTTP request target/path. Both the HTTP method and request target may be specified in the first line (or “start line”) of the HTTP request.

Reference is made herein to a “type” of an API call. As used herein, this refers to distinct action being requested by the API call in combination with a type of resource being acted upon. For example, in the case of a storage system, an API call to create a storage group may be considered one type of API call, whereas an API call to read information about a storage group may be considered a different type. As another example, an API call to read information about a LUN may be treated as distinct from an API to read information about a storage group. Thus, in the case of a REST API, the “type” may correspond to the combination of HTTP request method and target/path. In some cases, the “type” of an API call can be defined by an API endpoint used to initiate that call.

In some cases, API module 208 may authenticate API calls, for example by verifying that valid authentication credentials are included in the HTTP request header. Various authentication schemes may be used, such as password-based, certificate-based, token-based, etc. and the particular scheme used may be selected based on the security requires for a given application. If an API call cannot be verified, API module 208 may send a response back to the client device 204 indicating that the API call was not successfully completed. In the case of a REST API, the response may be an HTTP response with status code 401 (Unauthorized).

Based on the type of resource being acted upon, API module 208 can route the call to a particular one of the management modules 210 for processing/handling. Subsequently, API module 208 can send a response back to the client device 204 indicating whether the API call was successful (the response can also include payload information specific to the API call). In the case of a REST API, an HTTP response status code may be used to indicate whether the API call was successfully completed. Here, a status code in the range 200 to 299 may indicate that a request was successfully completed, whereas a status code outside this range may indicate that it was not successfully completed due to a malformed request, timeout, an unexpected server error, or some other error condition.

Herein, the terms “error” and “error condition” used in conjunction with an API call refer to any anomalous condition associated with the handling of an API call. This can include conditions that prevent an API call from being successfully completed as well as conditions that prevent an API from being completed in a normal/expected amount of time.

In some cases, the handling of an API call may involve communicating with one or more of the subsystems 206. For example, an API call may be a call to read information about a particular resource 207 (e.g., a storage device or other component of a storage system). In this case, a management module 210 may forward the API call (or a representation thereof) to the subsystem 206 for processing. The subsystem 206 can process the API call and return the results back to the management module 210 along with a status code indicating whether the API call was successfully processed by the subsystem. In turn, API module 208 may use the subsystem-returned status code to prepare and send a response to the client device 204. If call to the subsystem 206 fails to complete due to a transient communications error, timeout, or other error condition, then API module 208 may response to the client device 204 with an appropriate error status code. In some cases, an API call may fail to complete due to high load/activity on a particular subsystem 206.

As previously discussed, certain types of API call errors may be resolvable by a user or system administrator, provided that the user/administrator has sufficient information regarding the nature and context of the errors. Accordingly, management server 202 can include an API detection and remediation module 214 configured to detect errors/anomalies with API calls and to generate recommendations as to specific action(s) that can be taken to resolve or manage such errors, thereby enabling or facilitating remediation of the errors.

In some embodiments, module 214 can detect API call errors based on statistical analysis of prior API calls. In more detail, when a client device 204 makes an API call to management server 202, API module 208 can store details of the call to a database 216. For example, API module 208 may store the type of the API call (e.g., the API endpoint used to initiate the call), the response status code, the duration of the call (e.g., the total time taken to process the API call, including time taken by the management server 202 and any subsystem 206 to process the call), among other relevant data about the call. During subsequent API calls, API detection and remediation module 214 can use historical API call data stored in database 216 to detect errors, such as calls that are taking unusually long to complete. For example, the duration of a current API call can be compared with a historical average (e.g., mean and/or median) computed for past calls of the same type. If the current API call duration is greater than the historical average (or greater than an upper bound derived therefrom), then module 214 can detect an anomaly with the current call and recommend action(s) to prevent subsequent calls from taking longer than expected.

Database 216 can include a relational database, an object database, a key-value store, or any other type of database capable of storing and retrieving API call details along with other types of data/information disclosed as being stored within database 216.

In addition to using historical API call data, module 214 can detect errors by inspecting response status codes generated by management server 202 and/or a given subsystem 206. For example, in the case of a REST API, module 214 can detect an error with an API call if the response status code generated for that call is outside the range 200 to 299.

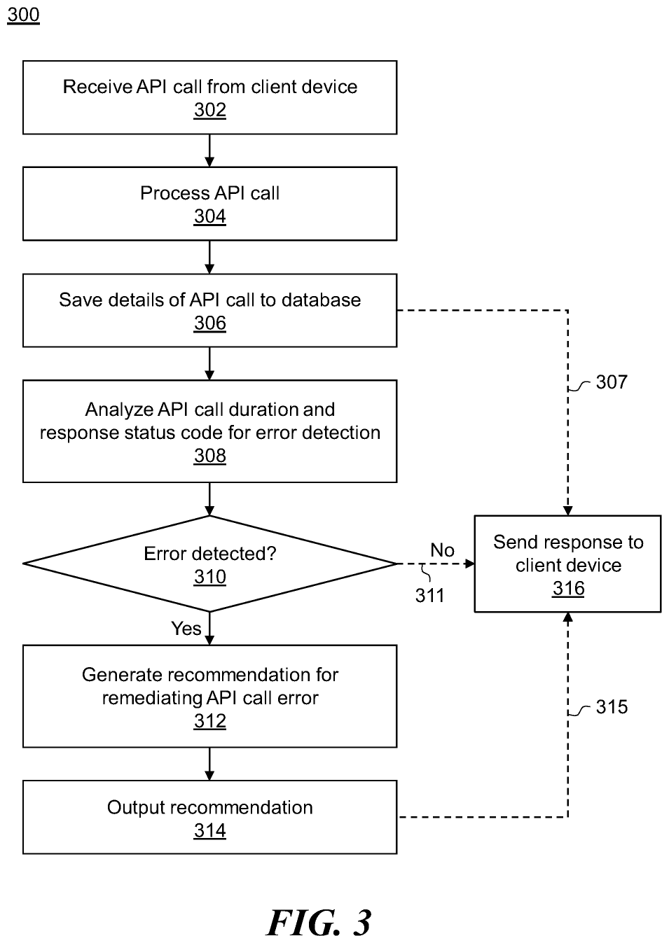

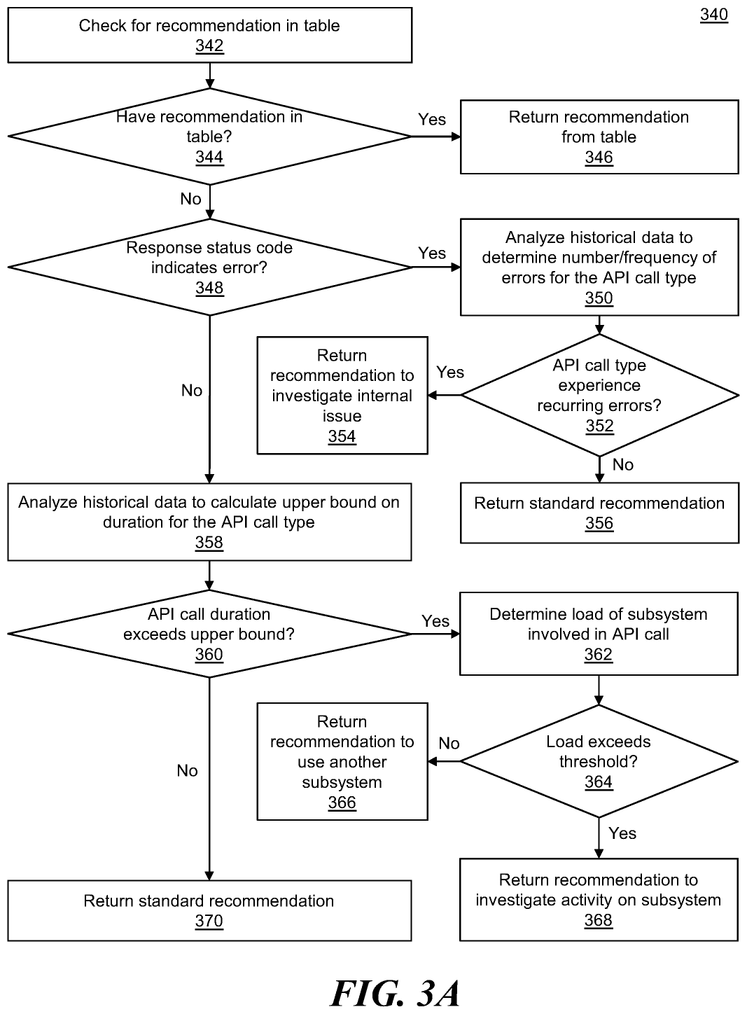

Having detected an error with an API call, module 214 can generate a recommendation for remediating the error. The recommendation can be based on various factors, such as the particular response status code for the call and historical API call data stored in database 216. In some embodiments, management server 202 can include or otherwise have access to a table of recommendations for particular types of errors. For example, this table can be stored in database 216 and managed via an administrative user interface (UI) of server 202. In any case, when an API call error is detected, module 214 can check the table for an existing recommendation. A detailed procedure for detecting API errors and providing such recommendations is described below in the context of FIGS. 3 and 3A.

Module 214 can output API call recommendations in one or more different forms. For example, in some embodiments, management server 202 may include an administrative user interface (UI) for displaying notifications and alerts, among various other administrative information related to system 200. In such embodiments, module 214 may cause a recommendation to be presented as a notification/alert with the administrative UI. In some embodiments, module 214 may store recommendations within database 216 where they can be subsequently accessed for display by the administrative UI. As another example, module 214 can cause a recommendation to be sent back to the client device 204 that initiated the API call for which an error was detected. The recommendation can be included within the API call response, or sent as a separate communication.

FIGS. 3 and 3A show examples of processes for API error detection and remediation, according to some embodiments. The processes can be implemented, for example, within management server 202 of FIG. 2 or, more particularly, within API error detection and remediation module 214 of FIG. 2.

Turning to FIG. 3, an illustrative process 300 begins at block 302, where an API call is received from a client device. At block 304, the API call may be processed. For example, the API call may be forwarded to or more subsystems (e.g., storage arrays) to retrieve information about one or more components thereof (e.g., storage devices, storage groups, storage volumes, etc.). A response status code can be generated as a result of the processing, as previously discussed.

At block 306, details of the API call (e.g., the type of the API call, the response status code, the duration of the call processing, etc.) can be saved to a database (e.g., database 216 of FIG. 2) alongside details of prior API calls. In some embodiments, a response can then be immediately sent back to the client device (block 316) as indicated by dashed line 307. In other embodiments, a response may be sent later in the process, as indicated by dashed lines 311, 315.

At block 308, the API call duration and response status code can be analyzed to detected if there was an error condition associated with the API call. In some cases, an error is detected if the call duration exceeds an upper bound calculated based on a historical average of call durations for the same type of API call, as discussed further below in the context of FIG. 3A. In some cases, an error is detected if the response status code is outside of a given range of values, such as outside the range 200 to 299 (e.g., in the case of a REST API call).

If no error is detected, then, at block 310, a response can be sent back to the client device (line 311 and block 316, if not already sent) and process 300 may terminate.

If an error is detected, then, at block 312, a recommendation for remediating the API call error can be generated. At block 314, the recommendation can be output in or more different forms. For example, the recommendation may be displayed as a notification/alert within an administrative UI. As another example, the recommendation may be included within a response sent back to the client device (line 315 and block 316). In more detail, the recommendation may encoded as a string that is included in the header or body of response (e.g., with an HTTP response header).

FIG. 3A shows an example of a process 340 for generating a recommendation for remediating an API call error, according to some embodiments. Process may be utilized, for example, within block 312 of FIG. 3, or may be used separate from the process of FIG. 3.

At block 342, once an error is detected, a check can be performed to determine if a known recommendation exists for the particular type of error. For example, the database table can be checked to find a recommendation for the particular type of error. The table can have one or more columns that identify the type of error, and one or more other columns that specify the recommendation (e.g., encoded as string value). The type of error can be determined using a combination of information/fields associated with the API call, such as the type of API call and the response status code.

At block 344, if a known recommendation is found in the table, that recommendation can be returned (at block 346) by process 340. That is, the recommendation can be output in one or more forms as previously discussed. Otherwise, if no recommendation is found in the table, the process 340 can proceed to block 348.

At block 348, if the response status code indicates an error (e.g., is outside the range 200 to 299), then, at block 350, historical API call data can be analyzed to determine how often this type of API call experiences an error. For example, a total number of errors can be calculated or a frequency of errors can be calculated (e.g., number of errors in a given time period). The calculated total number/frequency can be compared to a predetermined threshold value to determine if the API call type is experiencing recurring errors. If, at block 352, there are many/frequent errors for this type of API call, then, at block 354, process 340 can return a recommendation to investigate an internal issue with a subsystem involved in the API call. Otherwise, a standard recommendation can be returned at block 356. A standard recommendation can include a notification/alert that there was an isolated error with the API call.

In some embodiments, if the response status code indicates an authentication or authorization errors has occurred (e.g., a HTTP response status code of 401), process 340 may return a recommendation for the user to check their authenticate credentials and/or verify whether they have sufficient permission to make this type of API call.

If the response status code does not indicate an error, then processing may continue at block 358, where an upper bound on the duration for this type of API call is calculated. For example, the mean or median call duration can be calculated, and then the upper bound calculated as X % more than this historical average (e.g., 10%, 15%, 25%, 50%, etc. more).

At block 360, if the API call duration exceeds the calculated upper bound, then, at block 362, a load (or “activity level”) can be determined for a subsystem (e.g., storage array) involved in the API call, using any suitable known technique. If the load on the subsystem exceeds a predetermined threshold load, then a recommendation can be returned to investigate activity on the subsystem (block 368). Otherwise, process 340 can return a recommendation to use a different subsystem (block 366). For example, if creating storage groups on a first array is very slow due to other processes, process 340 can return a recommendation to use a second, different array (e.g., another array selected at random or based on measured load). A user/admin that receives the recommendation can then decide whether the wish to create the storage group on the second array or wait for the first array to recover.

If no recommendation has been returned, process 340 can return a standard recommendation by default at block 370.

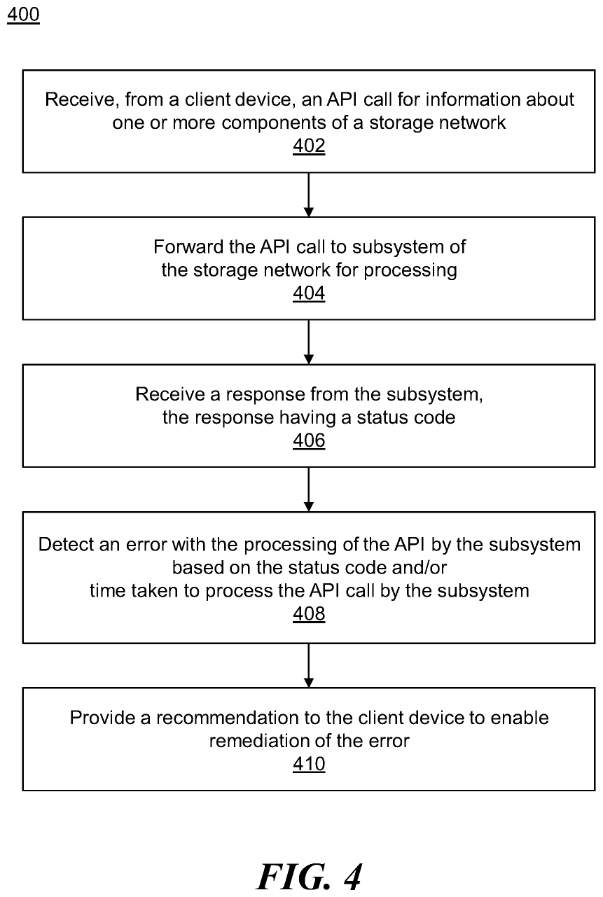

FIG. 4 is a flow diagram illustrating a process 400 for API error detection and remediation, according to some embodiments. Process 400 can be utilized, for example, within management server 202 of FIG. 2.

At block 402, an API call for information about one or more components of a storage network can be received from a client device. At block 404, the API call can be forwarded to a subsystem of the storage network for processing. For example, the API call (or a representation thereof) may be forwarded to a storage array for processing. At block 406, a response can be received from the subsystem, the response having a status code.

At block 408, an error/anomaly can be detected with the processing of the API call by the subsystem based, at least in part, on the status code and on comparing a time taken by the subsystem to process the API call to times taken to process other API calls. In some embodiments, the API call can include a Hypertext Transfer Protocol (HTTP) request and the detecting of the error with the processing of the API call by the subsystem based includes determining if the response status code is between 200 and 299. In some embodiments, the detecting of error with the processing of the API call by the subsystem can include detecting an authentication/authorization error based on the response status code, and wherein the providing of the recommendation to the client device to enable remediation of the error includes providing a recommendation that permissions associated with the client device are insufficient for the API call.

At block 410, in response to the detecting of the error, a recommendation can be provided to the client device to enable remediation of the error. In some embodiments, this can include providing the recommendation within an API response sent to the client device. In some embodiments, this can include presenting a graphical user interface (GUI) accessible by the client device, the GUI displaying the recommendation. In some embodiments, this can include determining a load of the subsystem and providing a recommendation not to use at least one of the one or more components of the storage network based on determined load.

In some embodiments, process 400 can further include storing information about the API call and the response to a database, the stored information including at least a type of the API call, the response status code, and the time taken by the subsystem to process the API call.

In some embodiments, process 400 can further include receiving another API call for information about one or more components of the storage network, where the another API call is associated with another client device. Subsequently, process 400 can detect an error with the processing of the another API call using at least the information about the API call stored to the database.

Process 400 can include various other features and embodiments disclosed herein, including but not limited to those described above in the context of FIGS. 2, 3, and 3A.

FIG. 5 shows an illustrative server device 500 that may implement various features and processes as described. The server device 500 may be implemented on any electronic device that runs software applications derived from compiled instructions, including without limitation personal computers, servers, smart phones, media players, electronic tablets, game consoles, email devices, etc. In some implementations, the server device 500 may include one or more processors 502, volatile memory 504, non-volatile memory 506, and one or more peripherals 508. These components may be interconnected by one or more computer buses 510.

Processor(s) 502 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 510 may be any known internal or external bus technology, including but not limited to ISA, EISA, PCI, PCI Express, NuBus, USB, Serial ATA or FireWire. Volatile memory 504 may include, for example, SDRAM. Processor 502 may receive instructions and data from a read-only memory or a random access memory or both. The essential elements of a computer may include a processor for executing instructions and one or more memories for storing instructions and data.

Non-volatile memory 506 may include by way of example semiconductor memory devices, such as EPROM, EEPROM, and flash memory devices; magnetic disks such as internal hard disks and removable disks; magneto-optical disks; and CD-ROM and DVD-ROM disks.

Non-volatile memory 506 may store various computer instructions including operating system instructions 512, communication instructions 514, application instructions 516, and application data 517. Operating system instructions 512 may include instructions for implementing an operating system (e.g., Mac OS®, Windows®, or Linux). The operating system may be multi-user, multiprocessing, multitasking, multithreading, real-time, and the like. Communication instructions 514 may include network communications instructions, for example, software for implementing communication protocols, such as TCP/IP, HTTP, Ethernet, telephony, etc.

Peripherals 508 may be included within the server device 500 or operatively coupled to communicate with the server device 500. Peripherals 508 may include, for example, network interfaces 518, input devices 520, and storage devices 522. Network interfaces may include for example an Ethernet or Wi-Fi adapter. Input devices 520 may be any known input device technology, including but not limited to a keyboard (including a virtual keyboard), mouse, trackball, and touch-sensitive pad or display. Storage devices 522 may include one or more mass storage devices for storing data files; such devices include magnetic disks, such as internal hard disks and removable disks; magneto-optical disks; and optical disks.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. The program logic may be run on a physical or virtual processor. The program logic may be run across one or more physical or virtual processors.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method comprising:
receiving, by a management server of a storage network, an application programming interface (API) call for information about one or more components of the storage network, the API call received from a client device;
forwarding the API call to a subsystem of the storage network for processing;
receiving a response from the subsystem, the response having a status code;
detecting an error with the processing of the API call by the subsystem based, at least in part, on the status code and on comparing a time taken by the subsystem to process the API call to times taken to process other API calls; and
in response to the detecting of the error, providing a recommendation to the client device to enable remediation of the error.

2. The method of claim 1, further comprising:
storing information about the API call and the response to a database, the stored information including at least a type of the API call, the response status code, and the time taken by the subsystem to process the API call.

3. The method of claim 2, further comprising:
receiving, by the management server, another API call for information about one or more components of the storage network, the another API call associated with another client device; and
detecting an error with the processing of the another API call using at least the information about the API call stored to the database.

4. The method of claim 1, wherein the providing of the recommendation to the client includes providing the recommendation within a response sent by the management server to the client device.

5. The method of claim 1, wherein the providing of the recommendation to the client device includes presenting a graphical user interface (GUI) accessible by the client device, the GUI displaying the recommendation.

6. The method of claim 1, wherein the API call includes a Hypertext Transfer Protocol (HTTP) request and the detecting of the error with the processing of the API call by the subsystem based includes determining if the response status code is between 200 and 299.

7. The method of claim 1, wherein the providing of the recommendation to the client device to enable remediation of the error includes:
determining a load of the subsystem; and
providing a recommendation not to use at least one of the one or more components of the storage network based on determined load.

8. The method of claim 1, wherein the detecting of error with the processing of the API call by the subsystem includes detecting an authentication error based on the response status code, and wherein the providing of the recommendation to the client device to enable remediation of the error includes providing a recommendation that permissions associated with the client device are insufficient for the API call.

9. An apparatus comprising:
a processor; and
a non-volatile memory storing computer program code that when executed on the processor causes the processor to execute a process including:
receiving an application programming interface (API) call for information about one or more components of a storage network, the API call received from a client device;
forwarding the API call to a subsystem of the storage network for processing;
receiving a response from the subsystem, the response having a status code;
detecting an error with the processing of the API call by the subsystem based, at least in part, on the status code and on comparing a time taken by the subsystem to process the API call to times taken to process other API calls; and
in response to the detecting of the error, providing a recommendation to the client device to enable remediation of the error.

10. The apparatus of claim 9, the process further including:
storing information about the API call and the response to a database, the stored information including at least a type of the API call, the response status code, and the time taken by the subsystem to process the API call.

11. The apparatus of claim 10, the process further including:
receiving another API call for information about one or more components of the storage network, the another API call associated with another client device; and
detecting an error with the processing of the another API call using at least the information about the API call stored to the database.

12. The apparatus of claim 9, wherein the providing of the recommendation to the client includes providing the recommendation within a response sent to the client device.

13. The apparatus of claim 9, wherein the providing of the recommendation to the client device includes presenting a graphical user interface (GUI) accessible by the client device, the GUI displaying the recommendation.

14. The apparatus of claim 9, wherein the API call includes a Hypertext Transfer Protocol (HTTP) request and the detecting of the error with the processing of the API call by the subsystem based includes determining if the response status code is between 200 and 299.

15. The apparatus of claim 9, wherein the providing of the recommendation to the client device to enable remediation of the error includes:
determining a load of the subsystem; and
providing a recommendation not to use at least one of the one or more components of the storage network based on determined load.

16. The apparatus of claim 9, wherein the detecting of error with the processing of the API call by the subsystem includes detecting an authentication error based on the response status code, and wherein the providing of the recommendation to the client device to enable remediation of the error includes providing a recommendation that permissions associated with the client device are insufficient for the API call.

17. A non-transitory machine-readable medium encoding instructions that when executed by one or more processors cause a process to be carried out, the process comprising:
receiving, by a management server of a storage network, an application programming interface (API) call for information about one or more components of the storage network, the API call received from a client device;
forwarding the API call to a subsystem of the storage network for processing;
receiving a response from the subsystem, the response having a status code;
detecting an error with the processing of the API call by the subsystem based, at least in part, on the status code and on comparing a time taken by the subsystem to process the API call to times taken to process other API calls; and
in response to the detecting of the error, providing a recommendation to the client device to enable remediation of the error.

18. The non-transitory machine-readable medium of claim 17, the process further comprising:
storing information about the API call and the response to a database, the stored information including at least a type of the API call, the response status code, and the time taken by the subsystem to process the API call.

19. The non-transitory machine-readable medium of claim 18, the process further comprising:
receiving, by the management server, another API call for information about one or more components of the storage network, the another API call associated with another client device; and
detecting an error with the processing of the another API call using at least the information about the API call stored to the database.

20. The non-transitory machine-readable medium of claim 17, wherein the providing of the recommendation to the client includes providing the recommendation within a response sent by the management server to the client device.
